(19) United States
(12) Patent Application Publication
(10) Pub. No.: US 2025/0131062 A1
(43) Pub. Date: Apr. 24, 2025

(54) STATISTICAL PROCESSING SYSTEM, DISPLAY CONTROL DEVICE AND STORAGE MEDIUM

(71) Applicant: CASIO COMPUTER CO., LTD., Tokyo (JP)

(72) Inventor: Manato ONO, Tokyo (JP)

(73) Assignee: CASIO COMPUTER CO., LTD., Tokyo (JP)

(21) Appl. No.: 18/921,298

(22) Filed: Oct. 21, 2024

(30) Foreign Application Priority Data
Oct. 23, 2023 (JP) 2023-181700

(51) Int. Cl. G06F 17/18; G06F 3/0482; G06T 11/20

(52) U.S. Cl. CPC G06F 17/18; G06F 3/0482; G06T 11/206

(57) ABSTRACT

A statistical processing system including a processor, in which the processor selectively performs plural types of statistical calculations, and controls such that at least part of options are different between a case where the processor controls a display to display options for types of statistical calculations to be selectively performed by the processor, in response to an operation performed on a list display area where a list of data to be used for statistical calculation is displayed, and a case where the processor controls the display to display options for types of statistical calculations to be selectively performed by the processor, in response to an operation performed on a graph display area where a graph indicating a result of statistical calculation is displayed.

### CROSS-REFERENCE TO RELATED APPLICATION

This application is based upon and claims the benefit of priority from the prior Japanese Patent Application No. 2023-181700 filed Oct. 23, 2023, the entire contents of which are incorporated herein by reference.

### BACKGROUND

### 1. Technical Field

The present disclosure relates to a statistical processing system, a display control device and a storage medium.

### 2. Description of the Related Art

Conventionally, a statistical processing device is known which performs processing of drawing a graph of statistical data and processing of finding calculation results such as standard deviations and graphical formulas from the statistical data, as described in, for example, Japanese Patent Application Laid-Open (Kokai) Publication No. H10-027163. Also, a statistical processing system has been proposed which provides the above-described statistical processing function by a terminal and a server connected through a network.

### SUMMARY

An embodiment of the present disclosure is a statistical processing system comprising a processor, wherein the processor selectively performs plural types of statistical calculations, and wherein the processor controls such that at least part of options are different between (i) a case where the processor controls a display to display options for types of statistical calculations to be selectively performed by the processor, in response to an operation performed on a list display area where a list of data to be used for statistical calculation is displayed, and (ii) a case where the processor controls the display to display options for types of statistical calculations to be selectively performed by the processor, in response to an operation performed on a graph display area where a graph indicating a result of statistical calculation is displayed.

Another embodiment of the present disclosure is a display control device comprising a processor, wherein the processor controls such that at least part of options are different between (i) a case where the processor controls a display to display options for types of statistical calculations, in response to an operation performed on a list display area where a list of data to be used for statistical calculation is displayed, and (ii) a case where the processor controls the display to display options for types of statistical calculations, in response to an operation performed on a graph display area where a graph indicating a result of statistical calculation is displayed.

Another embodiment of the present disclosure is a non-transitory computer-readable storage medium having stored thereon a program that is executable by a computer to perform processing of controlling such that at least part of options are different between (i) a case where a display is controlled to display options for types of statistical calculations, in response to an operation performed on a list display area where a list of data to be used for statistical calculation is displayed, and (ii) a case where the display is controlled to display options for types of statistical calculations, in response to an operation performed on a graph display area where a graph indicating a result of statistical calculation is displayed.

The above and further objects and novel features of the present disclosure will more fully appear from the following detailed description when the same is read in conjunction with the accompanying drawings. It is to be expressly understood, however, that the drawings are for the purpose of illustration only and are not intended as a definition of the limits of the disclosure.

### BRIEF DESCRIPTION OF THE DRAWINGS

FIG. 1 is a diagram showing an example of the structure of a system according to an embodiment;

FIG. 2 is an example of a flowchart of processing that is performed by the system according to the embodiment;

FIG. 3 is an example of a flowchart of processing according to options which is performed by the system according to the embodiment;

FIG. 4 is an example of a table which is referred to by the system according to the embodiment;

FIG. 5 is an example of a screen displayed on a terminal according to the embodiment;

FIG. 6 is another example of the screen displayed on the terminal according to the embodiment;

FIG. 7 is still another example of the screen displayed on the terminal according to the embodiment;

FIG. 8 is yet another example of the screen displayed on the terminal according to the embodiment;

FIG. 9 is yet another example of the screen displayed on the terminal according to the embodiment;

FIG. 10 is yet another example of the screen displayed on the terminal according to the embodiment;

FIG. 11 is yet another example of the screen displayed on the terminal according to the embodiment;

FIG. 12 is yet another example of the screen displayed on the terminal according to the embodiment;

FIG. 13 is yet another example of the screen displayed on the terminal according to the embodiment;

FIG. 14 is yet another example of the screen displayed on the terminal according to the embodiment;

FIG. 15 is yet another example of the screen displayed on the terminal according to the embodiment;

FIG. 16 is yet another example of the screen displayed on the terminal according to the embodiment;

FIG. 17 is an example of the division of roles between the terminal and a server in the system according to the embodiment;

FIG. 18 is another example of the division of roles between the terminal and the server in the system according to the embodiment; and

FIG. 19 is still another example of the division of roles between the terminal and the server in the system according to the embodiment.

### DETAILED DESCRIPTION OF THE PREFERRED EMBODIMENT

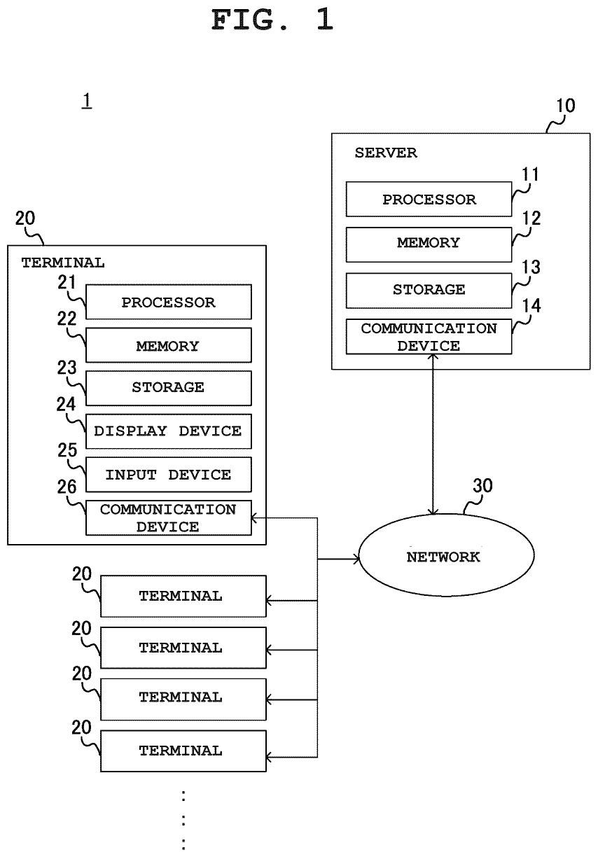

A system 1 shown in FIG. 1 includes, for example, a server 10 and one or more terminals 20. This server 10 and each terminal 20 are connected to each other through a network 30 such that communication can be performed. The network 30 herein is constituted by, for example, a LAN (Local Area Network), the Internet, etc.

The server 10 is a computer having a communication function, and includes a processor 11, a memory 12, a storage 13, and a communication device 14. For example, the processor 11 includes at least one Central Processing Unit (CPU), and executes a program stored in the memory 12 or loaded into the memory 12 from the storage 13. Note that this processor 11 may include an arbitrary electrical circuit, such as a GPU (Graphics Processing Unit), an ASIC (Application Specific Integrated Circuit), and a FPGA (Field-Programmable Gate Array).

The memory 12 includes, for example, an arbitrary semiconductor memory. This memory 12 may include a volatile memory such as a RAM (Random Access Memory) and a non-volatile memory such as a ROM (Read Only Memory) and a flash memory. The storage 13 includes, for example, a magnetic storage device, an optical storage device, and other types of storage devices. The communication device 14 includes, for example, a communication circuit, and may be a device capable of wireless communication such as Wi-Fi (Wireless Fidelity) and BLE (Bluetooth Low Energy) or a device capable of cable communication.

Each terminal 20 is a display control device which controls display information to be provided to the user of the system 1, and is a personal computer, a tablet computer, a smartphone, an electronic dictionary terminal, a mobile phone, an electronic book terminal, a handheld game machine, etc. In the present embodiment, this terminal 20 is a computer having a communication function and includes, for example, a processor 21, a memory 22, a storage 23, a display device 24, an input device 25, and a communication device 26.

The processor 21 includes, for example, at least one CPU (Central Processing Unit) and the like. This processor 21 executes programs stored in the memory 22 or loaded into the memory 22 from the storage 23, and programs (scripts) received from the server 10 through the network 30. In this processor 21 as well, an arbitrary electrical circuit may be included, as in the case of the processor 11. The memory 22, the storage 23, and the communication device 26 are similar to the memory 12, the storage 13, and the communication device 14.

The display device 24 is merely an example of a display section in the present disclosure and includes, for example, a liquid crystal display, an organic electroluminescence display, a CRT (Cathode Ray Tube) display, etc. The input device 25 includes a keyboard, a mouse, a touch device, etc. The display device 24 and the input device 25 may constitute, for example, a touch panel display and be integrally formed. Also, the display device 24 and the input device 25 may be provided in the housing of a main body having the processor 21 and the like, or be provided separately from the main body.

The system 1 constituted as described above is merely an example of a statistical processing system which provides a statistical calculation function to the user of the system 1. This system includes a statistical calculation section which selectively performs plural types of statistical calculations, and a display control section. By the display control section controlling the display device 24 of the user's terminal 20 to display a result of statistical calculation performed by the statistical calculation section, the system 1 provides the user with the statistical calculation function.

Note that, in statistical calculation performed by the statistical calculation section of the system 1, the calculation of statistics, statistical estimation, statistical testing are included. Accordingly, the user's various requests regarding statistical calculation can be appropriately handled. More specifically, normal statistical calculation, regression analysis, testing, confidence intervals (interval estimation), distribution calculation, inverse distribution calculation, graphing may be included but the present disclosure is not limited thereto.

The system 1 is, for example, a Web application system. The user of the system 1 may use the statistical calculation function of the system 1 by accessing a Web application running on the server 10 via a web browser running on the terminal 20. This system 1 is only required to provide the statistical calculation function to the user by a client application installed in the terminal 20 and a server application running on the server 10 communicating with each other, and therefore is not limited to the Web application system.

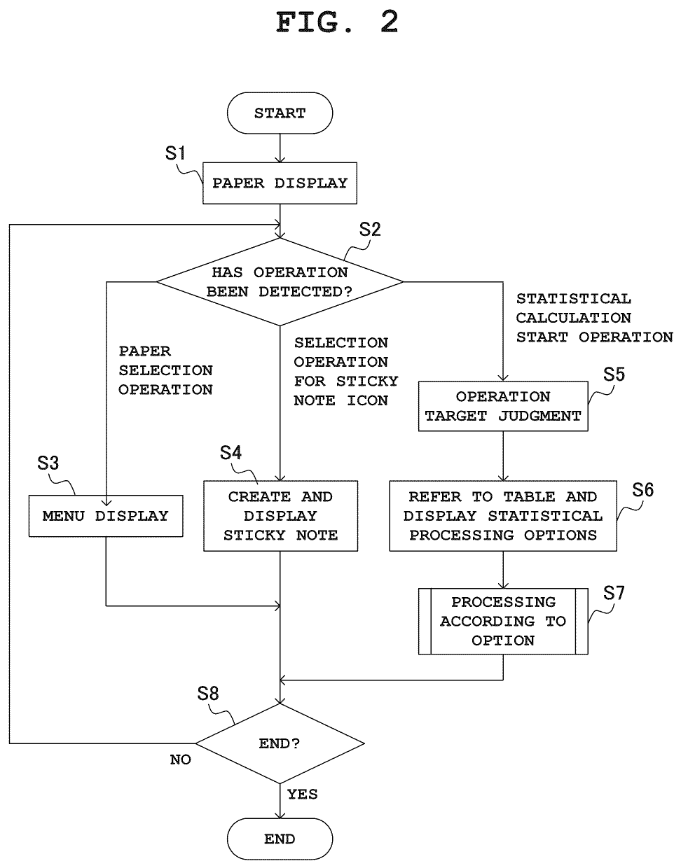

Hereinafter, a case is described in which the system 1 is a system for a Web application of an electronic notebook which records arbitrary information on the server 10, and the statistical calculation function is provided on the electronic notebook (hereinafter simply referred to as “notebook”). Here, information processing is described which is performed in the system 1 in response to an operation by the user of the terminal 20 in order to provide the statistical calculation function with reference to FIG. 2 to FIG. 16.

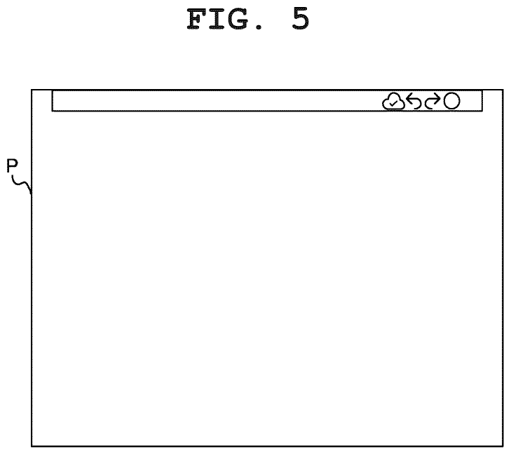

First, when the user accesses the Web application running on the server 10 by operating the terminal 20, the notebook is opened. Next, when an operation to open paper P for using the statistical calculation function on the notebook is performed, the system 1 starts processing shown in FIG. 2, and displays the paper P on the display device 24 of the terminal 20 (Step S1). FIG. 5 shows a state where the paper P has been displayed on the display device 24.

Then, the system 1 waits for the user's operation on the paper P (Step S2), and performs processing in accordance with a detected operation (Step S3, Step S4, Step S5, and the like).

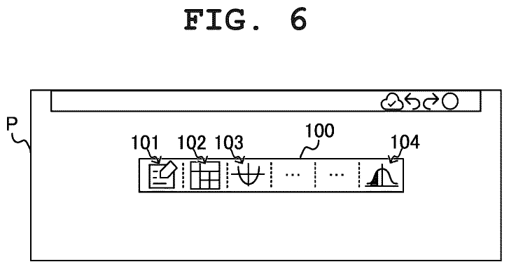

When a paper selection operation of selecting a blank space of the paper P is detected, the system 1 controls the display device 24 to display a menu 100 on the paper P (Step S3), as shown in FIG. 6. This menu 100 includes a plurality of icons (such as an icon 101, an icon 102, an icon 103, and an icon 104).

The icon 101 is used for giving an instruction to create a text sticky note, and the icon 102 is used for giving an instruction to create a statistical data sticky note. Also, the icon 103 is used for giving an instruction to create a statistical graph sticky note, and the icon 104 is used for giving an instruction to display options for statistical calculation. Note that the sticky note herein is a display area whose position can be freely changed within the paper P by the user, and is information to be recorded on the server 10. This sticky note is occasionally referred to as “sticky”.

When an operation (sticky note icon selection operation) on the icon 101 is detected, the system 1 creates a text sticky note in response to the operation, and displays it on the paper P on the display device 24. Note that this processing of creating and displaying a text sticky note is merely an example of the processing of Step S4. On the text sticky note, an arbitrary character string or the like can be written.

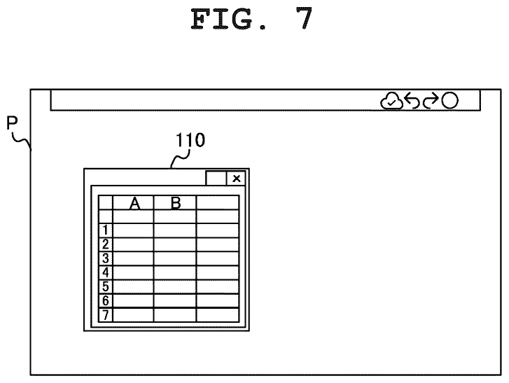

Also, when an operation (sticky note icon selection operation) on the icon 102 is detected, the system 1 creates a statistical data sticky note 110 shown in FIG. 7 in response to the operation, and displays it on the paper P on the display device 24. Note that this processing of creating and displaying a statistical data sticky note 110 is also an example of the processing of Step S4. In statistical calculation, a subset of a population, that is, a list of sample data is often used. The statistical data sticky note 110 is an example of a list display area where a list of such data for statistical calculation is displayed, which is also used as an area where a list of data is inputted.

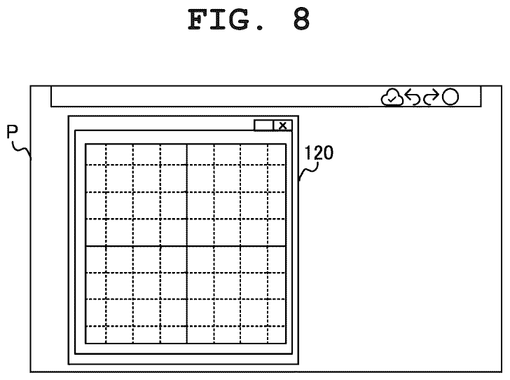

Moreover, when an operation (sticky note icon selection operation) on the icon 103 is detected, the system 1 creates a statistical graph sticky note 120 shown in FIG. 8 in response to the operation, and displays it on the paper P on the display device 24. Note that this processing of creating and displaying a statistical graph sticky note 120 is also an example of the processing of Step S4. The result of statistical calculation is often provided in graph form. The statistical graph sticky note 120 is an example of a graph display area where a graph indicating the result of statistical calculation is displayed.

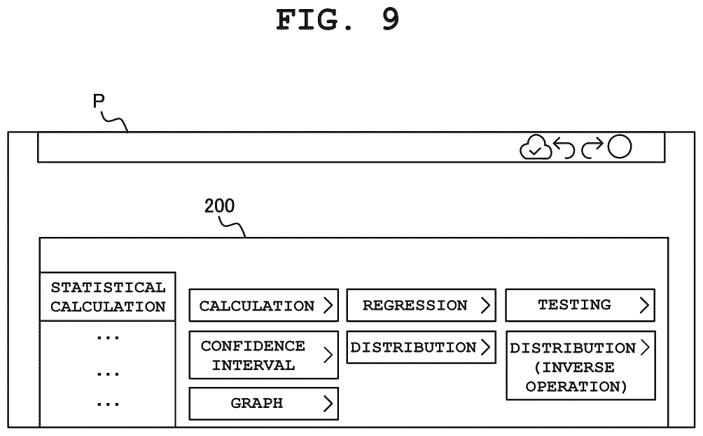

Furthermore, when an operation on the icon 104 is detected, the system 1 controls the display device 24 to display a menu 200 shown in FIG. 9 on the paper P in response to the operation. More specifically, the system 1 first judges an object (operation target) on which a detected operation has been performed (Step S5), and then displays the menu 200 including options for statistical processing with reference to a table on the basis of the judgment result (Step S6).

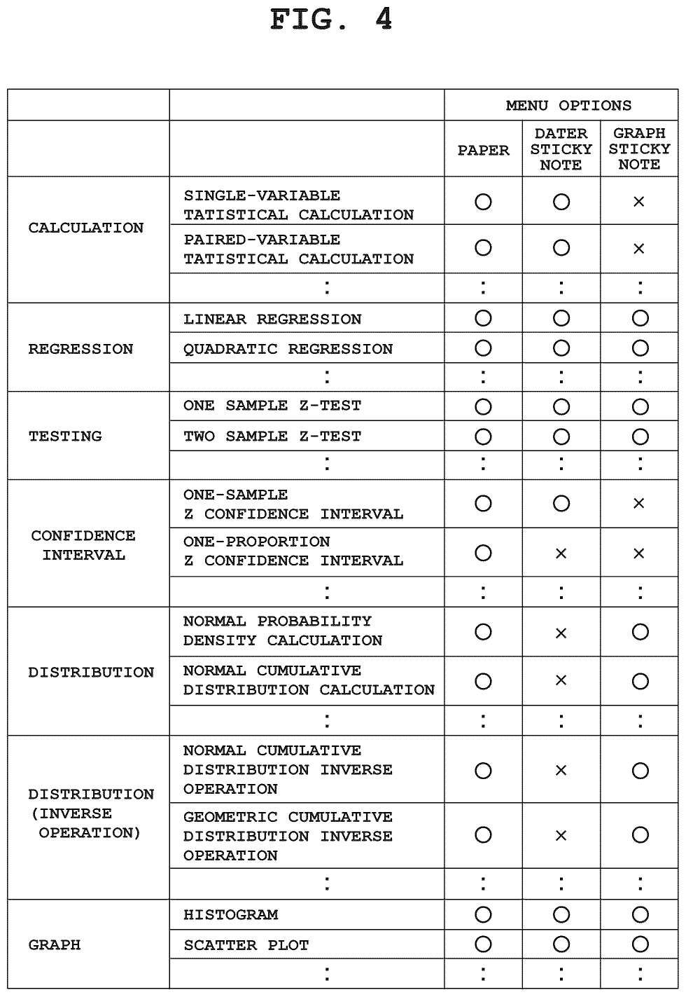

Here, at Step S5, the display control section of the system 1 judges that the icon 104 displayed on the paper P is an operation target. Then, at Step S6, the display control section of the system 1 acquires, as options to be displayed on the menu 200, information where ○ has been recorded on the “paper” column which is a column corresponding to the icon 104 on the paper P with reference a table T shown in FIG. 4 which has been stored in advance in the system 1, and displays the menu 200 having the acquired options.

The above-described information to be acquired from the table T at Step S6 may be hierarchical information. For example, the display control section may acquire “calculation”, “regression”, “testing”, “confidence interval”, “distribution”, “distribution (inverse operation)”, and “graph” as first level information, and then acquire second level information in association with particular information on the first level, as shown in FIG. 4. More specifically, “single-variable statistical calculation” and “paired-variable statistical calculation” may be acquired as second level information in association with “calculation” which is first level information, and “linear regression” and “quadratic regression” may be acquired as second level information in association with “regression” which is also first level information.

Note that the menu 200 to be displayed at Step S6 is an example of a menu display area where all types of statistical calculations that can be selectively performed by the statistical calculation section are displayed as options, and the selection operation to be performed on the icon 104 is an example of a statistical calculation start operation. The user selects an arbitrary type of statistical calculation from the plural types of statistical calculations displayed on the menu 200, and thereby controls the system 1 to perform processing in accordance with the selection (of statistical calculation type) at Step S7. A detailed procedure to statistical calculation after the selection will be described later.

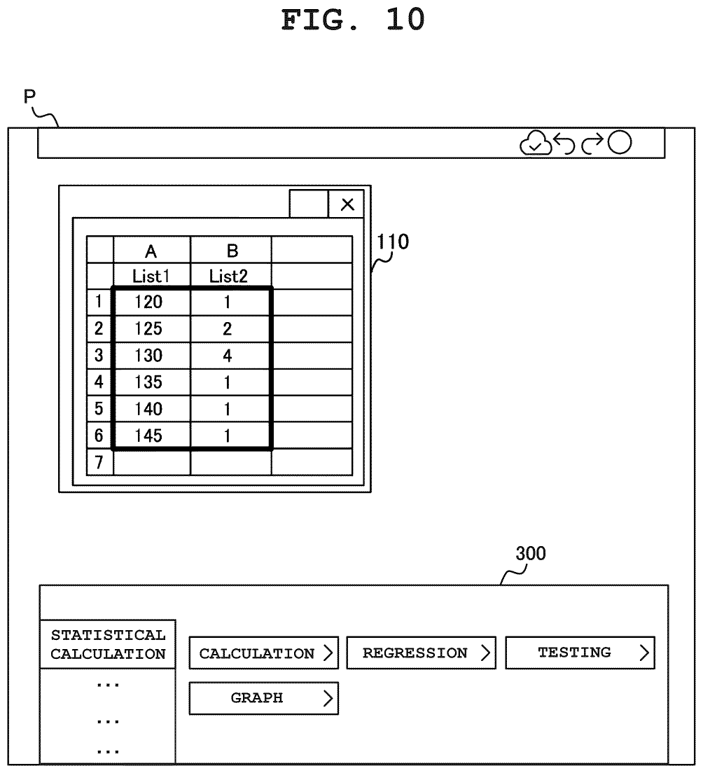

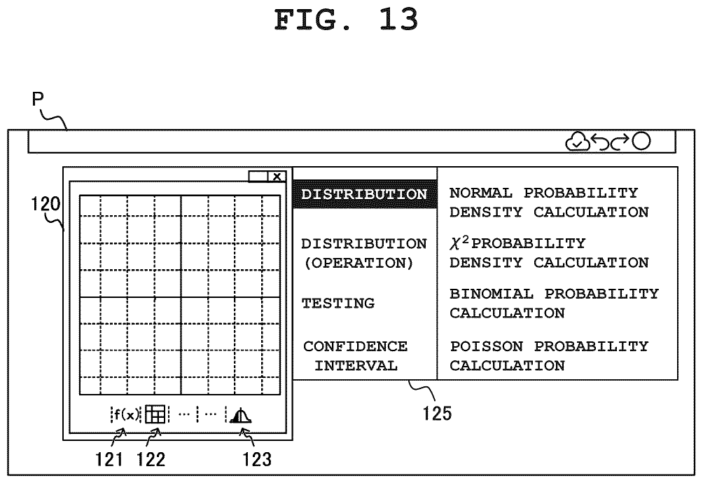

The menu 200 may have a hierarchized structure where a new option is displayed by an option on the menu 200 being selected, and the type of a statistical calculation to be performed may be determined by these options being selected in sequence. Note that all statistical calculations that can be selectively performed by the statistical calculation section are selectable from the menu 200, and this menu 200 differs from a menu 300 and a menu 125 described later (refer to FIG. 10 and FIG. 13) on this point.

As described above, the system 1 controls to display the menu 200, whereby the user can freely select the type of a statistical calculation to be performed by the statistical calculation section from all types of statistical calculations that are executable by the statistical calculation section.

Also, the system 1 can enable the user to select the type of a statistical calculation to be performed by the statistical calculation section from an object other than the menu 200, and details of which are described below.

For example, when an operation to select one or more cells in the statistical data sticky note 110 shown in FIG. 7 is detected, the system 1 controls the display device 24 to display the menu 300 shown in FIG. 10. More specifically, at Step S5, the system 1 first judges that the statistical data sticky note 110 is the object (operation target) on which the detected operation has been performed. Next, at Step S6, the system 1 acquires, as options to be displayed on the menu 300, information where ○ has been recorded on the “data sticky note” column which is a column corresponding to the statistical data sticky note 110, from the table T shown in FIG. 4 on the basis of the judgment result. Then, the system 1 controls to display the menu 300 having the acquired options.

Here, the above-described information where ○ has been recorded on the “data sticky note” column, that is, the options for types of statistical calculations to be displayed in response to the operation on the statistical data sticky note 110 (list display area) are options set in advance on the basis of a predetermined judgment criterion. More specifically, this information (options) is information determined in advance on the basis of a judgment criterion as to whether or not each type of statistical calculation requires the data of a list inputted into the statistical data sticky note 110. Accordingly, the above-described operation of the display control section of the system 1 for acquiring the information where ○ has been recorded on the “data sticky note” column as options to be displayed on the menu 300 is equivalent to an operation of setting in advance options for types of statistical calculations which are displayed in response to an operation on the list display area, on the basis of the predetermined judgment criterion, or more specifically, equivalent to an operation of determining on the basis of the judgment criterion as to whether or not each type of statistical calculation requires the data of the list.

Note that the above-described information where ○ has been recorded on the “data sticky note” column is not limited to the information determined in advance on the basis of the judgment criterion as to whether or not each type of statistical calculation requires the data of the list. This information where ○ has been recorded on the “data sticky note” column may be the information determined in advance on the basis of the judgment criterion as to whether or not each type of statistical calculation requires the data of the list, or may be information determined in advance on the basis of a judgment criterion as to whether or not each type of statistical calculation can use the data of the list. That is, the display control section may determine options to be displayed on the menu 300 on the basis of one of the judgment criteria. In addition, the table T may include columns corresponding to each judgment criterion so that the user can freely specify a judgment criterion to be used. In that case, the display control section may determine options to be displayed on the menu 300 on the basis of a judgment criterion specified by the user. Also, this judgment criterion of the present disclosure in not limited to the objective judgment criterion as to whether or not each type of statistical calculation requires the data of the list or whether or not each type of statistical calculation can use the data of the list, and may be a more subjective judgment criterion as to whether or not the list data should be used. Also, a configuration may be adopted in which the user can specify a judgment criterion to be actually used from among these arbitrary judgment criteria.

Note that the menu 300 to be displayed at Step S6 is an example of the menu display area where types of statistical calculations that can be selectively performed by the statistical calculation section are displayed as options, and the operation of selecting one or more cells in the statistical data sticky note 110 is an example of the statistical calculation start operation. The user selects an arbitrary type of statistical calculation from the plural types of statistical calculations displayed on the menu 300, and thereby controls the system 1 to perform processing in accordance with the selection (of statistical calculation type) at Step S7. A detailed procedure to statistical calculation after the selection will be described later.

As a result of the above-described configuration, the user is enabled to select the type of a statistical calculation to be performed from limited options, as compared to the case where all types of statistical calculations are displayed as options. More specifically, many cases of statistical calculations classified into distribution calculation, testing, and confidence intervals do not necessarily require data lists. In the configuration where the judgment criterion as to whether or not list data is necessary has been adopted, such types of statistical calculations can be eliminated from options so as not to be displayed. Also, in the configuration where the judgment criterion as to whether or not list data can be used has been adopted, types of statistical calculations that do not use lists can be eliminated from options so as not to be displayed. As a result, quick access to the user's desired statistical calculation can be provided.

More specifically, the display control section of the system 1 is configured to control the display device 24 to display the menu 300 as a menu display area that is independent from the statistical data sticky note 110 in response to an operation performed on the statistical data sticky note 110 (list display area), and then control the display device 24 to display options on the menu 300. This point is the same as the case where the display control section of the system 1 controls the display device 24 to display the menu 200 in response to an operation performed on the icon 104.

Here, relatively many types of statistical calculations are assumed to be displayed as the options in response to the operation performed on the statistical data sticky note 110. Therefore, the configuration where the display control section of the system 1 controls to display options on the menu display area that is independent from the statistical data sticky note 110 is preferable in that a relatively wide space for displaying options can be freely and easily acquired in the limited space within the paper.

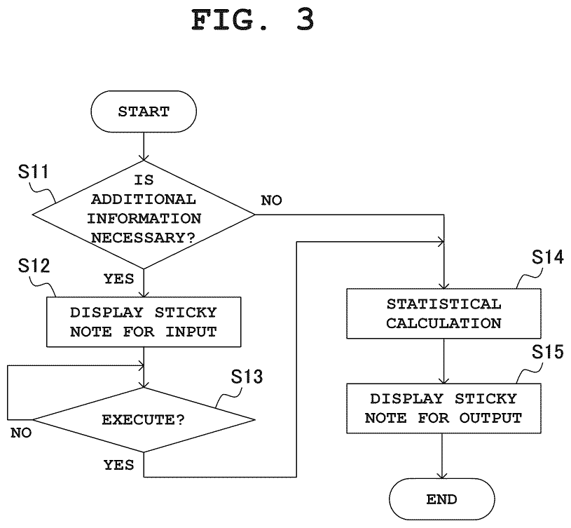

When the user selects one of the statistical calculations from the options displayed on the menu 300, the system 1 performs the processing of Step S7. In the processing of Step S7, the system 1 first judges whether or not additional input information is necessary for performing the selected statistical calculation (Step S11), as shown in FIG. 3.

When judged that no additional input information is necessary (NO at Step S11), the system 1 performs the selected statistical calculation (Step S14), and controls the display device 24 to display the result of the statistical calculation on a newly created sticky note for output (Step S15).

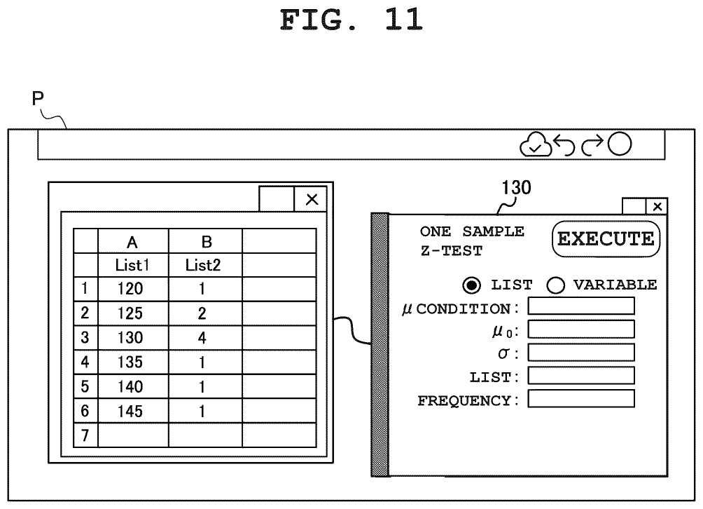

Conversely, when judged that additional input information is necessary (YES at Step S11), the system 1 controls the display device 24 to display a sticky note for input (Step S12). For example, when “one sample z-test” is selected from the options displayed at Step S6, the system 1 creates a statistical calculation sticky note 130 shown in FIG. 11 in response to this operation, and controls the display device 24 to display the statistical calculation sticky note 130 on the paper P. This statistical calculation sticky note 130 is displayed in association with the statistical data sticky note 110. More specifically, the statistical calculation sticky note 130 and the statistical data sticky note 110 are connected to each other via a line. Note that this statistical calculation sticky note 130 is an example of the sticky note for input.

Then, the system 1 waits for an execution operation for the statistical calculation (Step S13). When the user inputs necessary information into the statistical calculation sticky note 130 which is a sticky note for input, and presses an execution button provided on the statistical calculation sticky note 130, the system 1 detects this execution operation (YES at Step S13), performs the selected statistical calculation (Step S14), and controls the display device 24 to display a sticky note for output (Step S15).

At Step S14, the statistical calculation section performs the selected statistical calculation on the basis of the list of the data inputted into the statistical data sticky note 110 and the information inputted into the statistical calculation sticky note 130. For example, when “one sample z-test” is selected, and the execution button is pressed with “>” being inputted into to μ condition of the statistical calculation sticky note 130, “120” being inputted into μ0, “19” being inputted into σ, “List 1” being inputted into list, and “List 2” being inputted into frequency, the statistical calculation section calculates the number of sample data and a sample average value with reference to the list “list 1” of the data of the statistical data sticky note 110 and the list “list 2” thereof. Moreover, the statistical calculation section performs one sample z-test under conditions of the null hypothesis μ>120 and the population standard deviation σ=19 in addition to the calculated number of the sample data and the calculated sample average value.

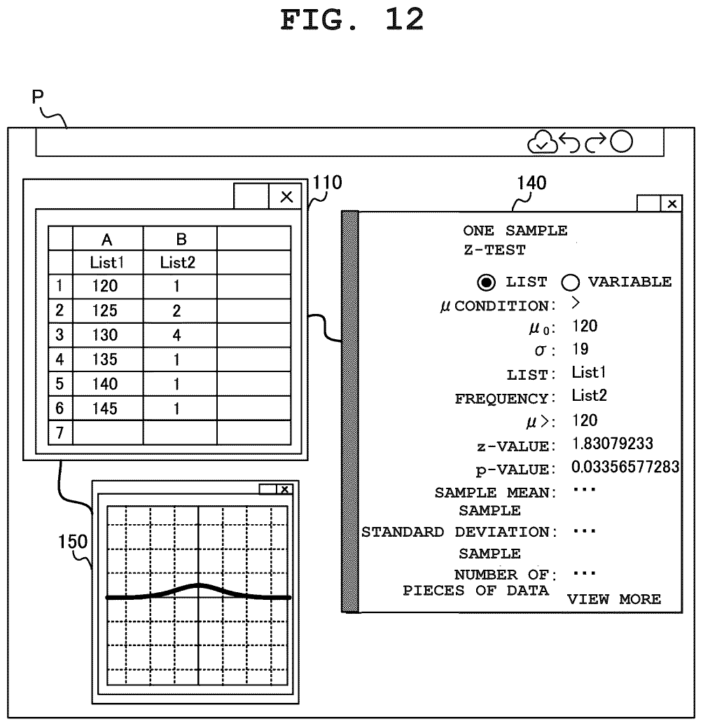

At Step S15, the system 1 creates a sticky note for output on the basis of the statistical calculation result, and controls the display device 24 to display the sticky note on the paper P. In the above-described case where one sample z-test has been performed, the system 1 updates the statistical calculation sticky note 130 which is a sticky note for input to a statistical calculation sticky note 140, and controls the display device 24 to display a statistical graph sticky note 150, as shown in FIG. 12. The statistical calculation sticky note 140 and the statistical graph sticky note 150 are displayed in association with the statistical data sticky note 110. More specifically, the statistical calculation sticky note 140 and the statistical graph sticky note 150 are connected to the statistical data sticky note 110 via lines. Note that the statistical calculation sticky note 140 and the statistical graph sticky note 150 are examples of the sticky note for output.

The statistical calculation sticky note 140 includes both the input information used for the statistical calculation and the output information which is the statistical calculation result. In addition, unlike the statistical calculation sticky note 130, the statistical calculation sticky note 140 displays the information such that it cannot be edited. Also, the statistical graph sticky note 150 includes a graph acquired by the statistical calculation result being drawn.

As described above, the system 1 enables the user to select the type of a statistical calculation to be performed by the statistical calculation section from the statistical data sticky note 110 in addition to the menu 200, and controls the display device 24 to display the result of the selected statistical calculation on the paper P. Also, the system 1 enables the user to select the type of a statistical calculation to be performed by the statistical calculation section from the statistical graph sticky note 120 in addition to the statistical data sticky note 110.

For example, when an operation to select the statistical graph sticky note 120 shown in FIG. 8 is detected, the system 1 controls the display device 24 to display a plurality of icons (icon 121, icon 122, icon 123) on the statistical graph sticky note 120, as shown in FIG. 13. The icon 121 is used to give an instruction to create a graphical formula sticky note. By a mathematical formula being inputted into the graphical formula sticky note, a graph corresponding to the mathematical formula is drawn on the statistical graph sticky note 120. The icon 122 is used to give an instruction to create a statistical data sticky note, and the icon 123 is used to give an instruction to display options for statistical calculation.

Also, when an operation to select the icon 123 among the icons displayed on the statistical graph sticky note 120 is detected, the system 1 controls the display device 24 to display the menu 125 shown in FIG. 13. More specifically, at Step S5, the system 1 first judges that the statistical graph sticky note 120 is the object (operation target) on which the operation has been performed. Next, at Step S6, the system 1 acquires, as options to be displayed on the menu 125, information where ○ has been recorded on the “graph sticky note” column which is a column corresponding to the statistical graph sticky note 120, from the table T shown in FIG. 4 on the basis of the judgment result. Then, the system 1 controls the display device 24 to display the menu 125 having the acquired options.

Here, the above-described information where ○ has been recorded on the “graph sticky note” column, that is, the options for types of statistical calculations to be displayed in response to the operation on the statistical graph sticky note 120 (graph display area) are options set in advance on the basis of a predetermined judgment criterion. More specifically, this information (options) is information determined in advance on the basis of a judgment criterion as to whether or not each type of statistical calculation requires graph drawing. Accordingly, the above-described operation of the display control section of the system 1 for acquiring the information where ○ has been recorded on the “graph sticky note” column as options to be displayed on the menu 125 is equivalent to an operation of setting in advance options for types of statistical calculations which are displayed in response to an operation on the graph display area, on the basis of the predetermined judgment criterion, or more specifically, equivalent to an operation of determining on the basis of the judgment criterion as to whether or not each type of statistical calculation requires graph drawing.

Note that the above-described information where ○ has been recorded on the “graph sticky note” column is not limited to the information determined in advance on the basis of the judgment criterion as to whether or not each type of statistical calculation requires graph drawing. This information where ○ has been recorded on the “graph sticky note” column may be the information determined in advance on the basis of the judgment criterion as to whether or not each type of statistical calculation requires graph drawing, or may be information determined in advance on the basis of a judgment criterion as to whether or not each type of statistical calculation can help the user's understanding by graph drawing. That is, the display control section may determine options to be displayed on the menu 125 on the basis of one of the judgment criteria. In addition, the table T may include columns corresponding to each judgment criterion so that the user can freely specify a judgment criterion to be used. In that case, the display control section may determine options to be displayed on the menu 125 on the basis of a judgment criterion specified by the user.

Note that the menu 125 to be displayed at Step S6 is an example of the menu display area where types of statistical calculations that can be selectively performed by the statistical calculation section are displayed as options, and the operation of selecting the predetermined icon (icon 123) on the statistical graph sticky note 120 is an example of the statistical calculation start operation. The user selects an arbitrary type of statistical calculation from the plural types of statistical calculations displayed on the menu 125, and thereby controls the system 1 to perform processing in accordance with the selection (of statistical calculation type) at Step S7.

As a result of the above-described configuration of the system 1, the user is enabled to select the type of a statistical calculation to be performed from limited options, as compared to the case where all types of statistical calculations are displayed as options. Accordingly, quick access to the user's desired statistical calculation can be provided.

More specifically, the display control section of the system 1 is configured to control the display device 24 to display the menu 125 as a menu display area derived from the statistical graph sticky note 120 in response to an operation performed on the statistical graph sticky note 120 (graph display area), and then control the display device 24 to display options on the menu 125. The configuration where options are displayed on the menu display area derived from the statistical graph sticky note 120 is preferable in that an option can be selected without the pointer being greatly moved on the screen, and this point is different from the cases where the menu 200 and the menu 300 are displayed on the display device 24.

When the user selects one of the statistical calculations from the options displayed on the menu 125, the system 1 performs the processing of Step S7. More specifically, the system 1 first judges whether or not additional input information is necessary for performing the selected statistical calculation (Step S11), as shown in FIG. 3.

When judged that no additional input information is necessary (NO at Step S11), the system 1 performs the selected statistical calculation (Step S14), and controls the display device 24 to display the result of the statistical calculation on a newly created sticky note for output (Step S15). This point is the same as the case where an option is selected from options displayed on the menu 300.

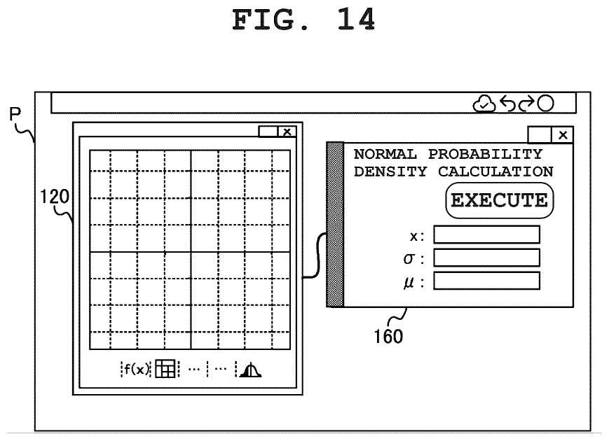

Conversely, when judged that additional input information is necessary (YES at Step S11), the system 1 controls the display device 24 to display a sticky note for input (Step S12). For example, when “normal probability density calculation” is selected from the options displayed at Step S6, the system 1 creates a statistical calculation sticky note 160 shown in FIG. 14 in response to this operation, and controls the display device 24 to display the statistical calculation sticky note 160 on the paper P. This statistical calculation sticky note 160 is displayed in association with the statistical graph sticky note 120. More specifically, the statistical calculation sticky note 160 and the statistical graph sticky note 120 are connected to each other via a line. Note that this statistical calculation sticky note 160 is an example of the sticky note for input.

Then, the system 1 waits for an execution operation for the statistical calculation (Step S13). When the user inputs necessary information into the statistical calculation sticky note 160 which is a sticky note for input, and presses an execution button provided on the statistical calculation sticky note 160, the system 1 detects this execution operation (YES at Step S13), performs the e selected statistical calculation (Step S14), and controls the display device 24 to display a sticky note for output (Step S15).

At Step S14, the statistical calculation section performs the selected statistical calculation on the basis of the information inputted into the statistical calculation sticky note 160. For example, when “normal probability density calculation” is selected, and the execution button is pressed with “1” being inputted into to x the statistical calculation sticky note 160, “1” being inputted into σ, and “1” being inputted into μ, the statistical calculation section performs normal probability density calculation with the inputted information as a condition.

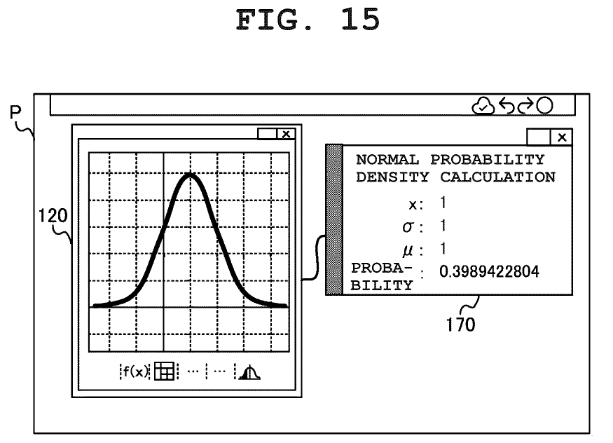

At Step S15, the system 1 creates a sticky note for output on the basis of the statistical calculation result, and controls the display device 24 to display the sticky note on the paper P. In the above-described case where normal probability density calculation has been performed, the system 1 updates the statistical calculation sticky note 160 which is a sticky note for input to a statistical calculation sticky note 170, and controls the display device 24 to display a graph where the statistical calculation result has been drawn on the statistical graph sticky note 120, as shown in FIG. 15. The statistical calculation sticky note 170 is displayed in association with the statistical graph sticky note 120. More specifically, the statistical calculation sticky note 170 and the statistical graph sticky note 120 are connected to each other via a line. Note that the statistical graph sticky note 120 and the statistical calculation sticky note 170 are examples of the sticky note for output.

Also, note that the statistical calculation sticky note 170 includes both the input information (x, σ, and μ) used for the statistical calculation and the output information which is the statistical calculation result. In addition, unlike the statistical calculation sticky note 160, the statistical calculation sticky note 170 displays the input information such that it cannot be edited.

As described above, the system 1 enables the user to select the type of a statistical calculation to be performed by the statistical calculation section from the statistical graph sticky note 120 in addition to the menu 200, and controls the display device 24 to display the result of the selected statistical calculation on the paper P.

This system 1 is capable of responding to an operation performed on a sticky note (the statistical data sticky note 110 or the statistical graph sticky note 120) related to the input/output of statistical calculation among the plural types of sticky notes, and thereby controlling the display device 24 to display types of statistical calculations related to the operated sticky note as options. Considering that the user is unlikely to perform statistical calculation that is not related to an operation target sticky note, the present configuration prevents the user's desired statistical calculation option from becoming unclear due to being mixed up with statistical calculation options not desired by the user. In addition, a situation is unlikely occur in which a statistical calculation option desired by the user is absent, which allows the user to use the statistical calculation function intuitively and stress-free. In particular, the present configuration is preferable in that, when an operation target is the statistical data sticky note 110 or the statistical graph sticky note 120, the statistical calculation section moderately downselects statistical calculations that can be selectively performed.

Also, the types of the related statistical calculations of the statistical data sticky note 110 and the statistical graph sticky note 120 are at least partially different. That is, the system 1 is configured such that options for types of statistical calculations to be displayed on the display device 24 at least partially differ between the case where the display control section controls the display device 24 to display in response to an operation performed on the statistical data sticky note 110 (list display area) and the case where the display control section controls the display device 24 to display in response to an operation performed on the statistical graph sticky note 120 (graph display area). Note that the above-described configuration where “options for types of statistical calculations at least partially differ” only requires that not all the options are the same between these cases. That is, a configuration where all the options are different between these cases may be adopted, or a configuration where parts of the options are the same and the rest of them are different between these cases may be adopted. As a result of this configuration, the system 1, which is capable of displaying options from both sticky notes, can ensure a sufficient number of types of quickly accessible statistical calculations and provide quick access to the user's desired statistical calculation.

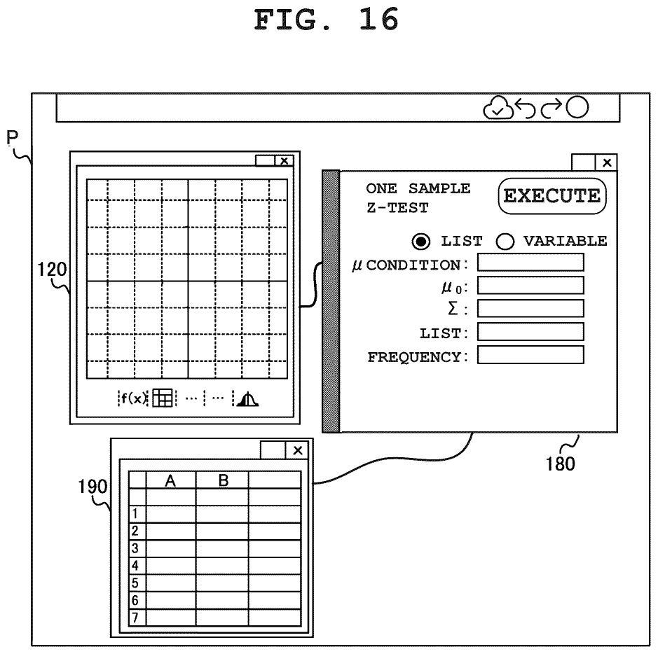

Also, in the above-described example, the statistical calculation where the user does not use a list of data is selected from the options displayed on the menu 125. However, for example, when a statistical calculation such as one sample z-test which can be calculated using a list of data is selected, the system 1 may display, as a sticky note for input, a statistical data sticky note 190 on the display device 24 in addition to the statistical calculation sticky note 180, as shown in FIG. 16.

Note that the above-described embodiment is merely an illustrative example for facilitating the understanding of the present disclosure, and the present disclosure is not limited to the above-described embodiment and should be understood as including various modifications and alternatives of the above-described embodiment. For example, it should be understood that the above-described embodiment can also be actualized by its structural components being altered without departing from the scope of the present disclosure. Also, it should be understood that various embodiments can be implemented by a plurality of components disclosed in the above-described embodiment being combined as necessary. Moreover, those skilled in the art should understand that various embodiments can be implemented by some components being excluded from or added to the components shown in the present embodiment. That is, the above-described statistical processing system, display control device, and program can be variously modified or altered within the scope of the appended claims.

In the above-described embodiment, as an example of the statistical processing system according to the present disclosure, the system 1 has been described which includes the statistical calculation section which selectively performs statistical calculation and the display control section which controls the display device 24 to display options for types of statistical calculations. However, the statistical calculation section and the display control section are only required to be provided in either one of the server 10 and the terminal 20 which constitute the system 1.

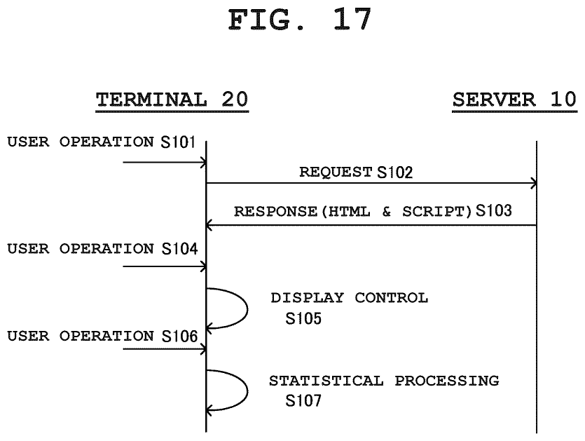

FIG. 17 is a diagram showing an example of the division of roles of the terminal 20 and the server 10 in the system 1, in which both the statistical calculation section and the display control section have been provided in the terminal 20. In other words, the processor 21 of the terminal 20 operates as the statistical calculation section and the display control section.

In the example shown in FIG. 17, when the terminal 20 transmits a request for a Web page to the server 10 in response to a user operation performed at Step S101 (Step S102), the server 10 transmits a Web page containing a script that is performed on the terminal 20 side (Step S103). Then, in response to a predetermined operation on the statistical data sticky note 110 or the statistical graph sticky note 120 (Step S104), the terminal 20 performs display control to display options for types of statistical calculations by executing the script received at Step S103 (Step S105). In addition, in response to an operation of giving an instruction to perform statistical calculation (Step S106), the terminal 20 performs a statistical calculation selected from the options by executing the script received at Step S103 (Step S107).

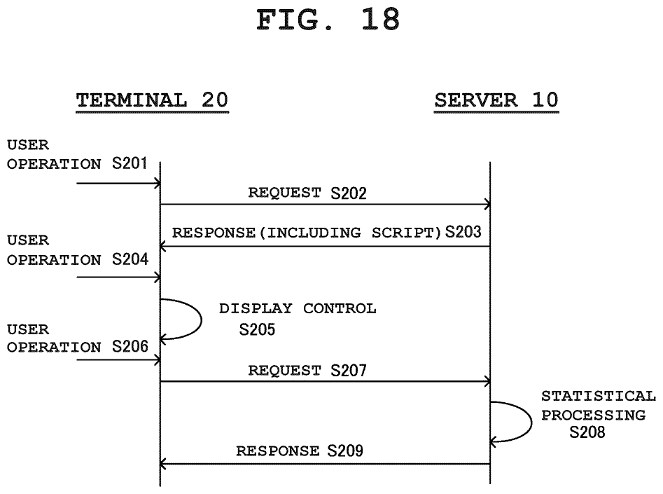

FIG. 18 is a diagram showing another example of the division of roles of the terminal 20 and the server 10 in the system 1, in which the statistical calculation section has been provided in the server 10 and the display control section has been provided in the terminal 20. In other words, the processor 11 of the server 10 operates as the statistical calculation section, and the processor 21 of the terminal 20 operates as the display control section.

In the example shown in FIG. 18, when the terminal 20 transmits a request for a Web page to the server 10 in response to a user operation performed at Step S201 (Step S202), the server 10 transmits, for example, a Web page containing a script that is performed on the terminal 20 side (Step S203). Then, in response to a predetermined operation on the statistical data sticky note 110 or the statistical graph sticky note 120 (Step S204), the terminal 20 performs display control to display options for types of statistical calculations by executing the script received at Step S203 (Step S205). In addition, when an operation of giving an instruction to execute a statistical calculation is performed (Step S206), the terminal 20 requests the server 10 to execute the statistical calculation (Step S207), and the server 10, which has received the request, performs the statistical calculation (Step S208) and transmits a Web page having the result of the statistical calculation to the terminal 20 (Step S209).

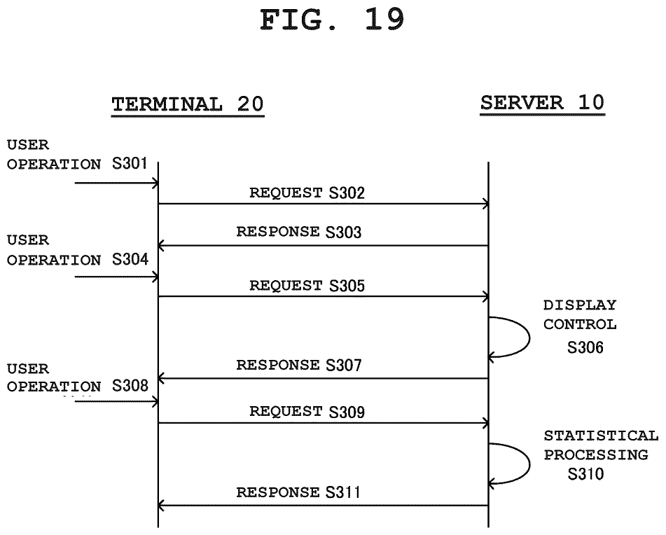

FIG. 19 is a diagram showing still another example of the division of roles of the terminal 20 and the server 10 in the system 1, in which both the statistical calculation section and the display control section have been provided in the server 10. In other words, the processor 11 of the server 10 operates as the statistical calculation section and the display control section.

In the example shown in FIG. 19, when the terminal 20 transmits a request for a Web page to the server 10 in response to a user operation performed at Step S301 (Step S302), the server 10 transmits, for example, a Web page (Step S303). Next, in response to a predetermined operation on the statistical data sticky note 110 or the statistical graph sticky note 120 (Step S304), the terminal 20 transmits a request to the server 10 (Step S305), and the server 10, which has received the request, performs display control to display options for types of statistical calculations (Step S306), and transmits a Web page containing this result to the terminal 20 (Step S307). Then, when an operation of giving an instruction to execute a statistical calculation is performed (Step S308), the terminal 20 requests the server 10 to execute the statistical calculation (Step S309), and the server 10, which has received the request, performs the statistical calculation (Step S310) and transmits a Web page having the result of the statistical calculation to the terminal 20 (Step S311).

In the above-described embodiment, as an example of the statistical processing system according to the present disclosure, the system 1 having the server 10 and the terminal 20 has been described. However, the statistical processing system is only required to have the statistical calculation section and the display control section, and the server 10 having both the statistical calculation section and the display control section or the terminal 20 having both the statistical calculation section and the display control section may constitute the statistical processing system. In that case, in the example shown in FIG. 17, the terminal 20 may be regarded as the statistical processing system. Also, in the example shown in FIG. 19, the server 10 may be regarded as the statistical processing system.

Also, although the system 1 having the server 10 and the terminal 20 has been described in the above-described embodiment as an example of the statistical processing system according to the present disclosure, the system 1 as the statistical processing system may be understood to be produced each time by communication processing between the server 10 and the terminal 20 which is performed to exert the statistical processing function by the statistical calculation section and the display control section.

Also, in the above-described embodiment, the terminal 20 has been described as an example of the display control device according to the present disclosure. However, the display control device is only required to be a device having a display control section, that is, a device which practically performs processing of controlling the display device 24 to display options for types of statistical calculations. Therefore, the display control device is not limited to the terminal 20 and may be the server 10. For example, in the cases of the examples shown in FIG. 17 and FIG. 18, the terminal 20 may be regarded as the display control device. In the case of the example shown in FIG. 19, the server 10 may be regarded as the display control device. By the display control device and the programs that are executed by the display control device, a sufficient number of types of quickly accessible statistical calculations can be ensured and quick access to the user's desired statistical calculation can be provided as described above. Moreover, by the display control device having the statistical calculation section in addition to the display control section as shown in FIG. 17, communication between the terminal 20 and the server 10 can be minimized, whereby the above-described functions can be provided while avoiding adverse effects and risks due to communication delay.

Also, in the example of the above-described embodiment, in response to an operation performed on the statistical data sticky note 110 that is the list display area or the statistical graph sticky note 120 that is the graph display area, the display control section controls the display device 24 to display options for selecting the type of a statistical calculation to be performed by the statistical calculation section. However, the list display area and the statistical graph sticky note 120 are not limited to areas or sticky notes whose positions in the display area (paper P in this example) of the display device 24 can be freely changed by the user. The list display area and the statistical graph sticky note 120 are only required be an area or a sticky note defined to be part of the display area of the display device 24 and to correspond to a specific function.

Also, in the above-described embodiment, although the example has been described in which the display control section controls the display device 24 to display options for selecting the type of a statistical calculation to be performed by the statistical calculation section, the display control section may further control the arrangement of the list display area and the graph display area. More specifically, the display control section may change, in response to an operation to move the statistical data sticky note 110, the position of the statistical data sticky note 110 in the display area of the display device 24 to a position specified by the moving operation. In addition, the display control section may change, in response to an operation to move the statistical graph sticky note 120, the position of the statistical graph sticky note 120 in the display area of the display device 24 to a position specified by the moving operation. This configuration enhances the user-friendliness of the system 1.

While the present invention has been described with reference to the preferred embodiment, it is intended that the invention be not limited by any of the details of the description therein but includes all the embodiments which fall within the scope of the appended claims.

What is claimed is:

1. A statistical processing system comprising a processor,
wherein the processor selectively performs plural types of statistical calculations, and
wherein the processor controls such that at least part of options are different between (i) a case where the processor controls a display to display options for types of statistical calculations to be selectively performed by the processor, in response to an operation performed on a list display area where a list of data to be used for statistical calculation is displayed, and (ii) a case where the processor controls the display to display options for types of statistical calculations to be selectively performed by the processor, in response to an operation performed on a graph display area where a graph indicating a result of statistical calculation is displayed.

2. The statistical processing system according to claim 1, wherein the processor sets in advance the options for types of statistical calculations which are displayed in response to the operation on the list display area and the options for types of statistical calculations which are displayed in response to the operation on the graph display area, on basis of predetermined judgment criteria.

3. The statistical processing system according to claim 2, wherein the processor determines the options for types of statistical calculations which are displayed in response to the operation on the list display area, on basis of a judgment criterion as to whether or not each type of statistical calculation requires the data of the list or a judgment criterion as to whether or not each type of statistical calculation is capable of using the data of the list.

4. The statistical processing system according to claim 2, wherein the processor determines the options for types of statistical calculations which are displayed in response to the operation on the graph display area, on basis of a judgment criterion as to whether or not each type of statistical calculation requires graph drawing or a judgment criterion as to whether or not graph drawing helps understanding of a user.

5. The statistical processing system according to claim 1, wherein the processor controls the display to display a menu display area independent from the list display area in response to the operation performed on the list display area, and display the options in the menu display area.

6. The statistical processing system according to claim 1, wherein the processor controls the display to display a menu display area derived from the graph display area in response to the operation performed on the graph display area, and display the options in the menu display area.

7. The statistical processing system according to claim 1, wherein the processor changes, in response to an operation of moving the list display area, a position of the list display area in a display area of the display to a position specified by the moving operation, and
wherein the processor changes, in response to an operation of moving the graph display area, a position of the graph display area in the display area of the display to a position specified by the moving operation.

8. The statistical processing system according to claim 1, wherein the plural types of statistical calculations include calculation of statistics, statistical estimation, and statistical testing.

9. A display control device comprising a processor,
wherein the processor controls such that at least part of options are different between (i) a case where the processor controls a display to display options for types of statistical calculations, in response to an operation performed on a list display area where a list of data to be used for statistical calculation is displayed, and (ii) a case where the processor controls the display to display options for types of statistical calculations, in response to an operation performed on a graph display area where a graph indicating a result of statistical calculation is displayed.

10. The display control device according to claim 9, wherein the processor selectively performs the plural types of statistical calculations in response to a selection operation performed on the options displayed on the display.

11. A non-transitory computer-readable storage medium having stored thereon a program that is executable by a computer to perform processing of controlling such that at least part of options are different between (i) a case where a display is controlled to display options for types of statistical calculations, in response to an operation performed on a list display area where a list of data to be used for statistical calculation is displayed, and (ii) a case where the display is controlled to display options for types of statistical calculations, in response to an operation performed on a graph display area where a graph indicating a result of statistical calculation is displayed.
